(19) United States
(12) Patent Application Publication
(10) Pub. No.: US 2020/0096152 A1
(43) Pub. Date: Mar. 26, 2020

(54) QUICK CONNECT PIVOT JOINTS

(71) Applicant: Hirotec America, Inc., Auburn Hills, MI (US)

(72) Inventors: Christopher J. Karras, Oxford, MI (US); Gerald F. Erker, Clarkston, MI (US)

(21) Appl. No.: 16/137,032

(22) Filed: Sep. 20, 2018

(51) Int. Cl. F16M 11/04; F16M 11/06

(52) U.S. Cl. CPC F16M 11/041; B21D 28/34; F16M 11/06

(57) ABSTRACT

A quick connect assembly includes a first leg, a second leg, a pivot pin, and a pivot arm. The first and second legs defined a gap therebetween. The first leg defines a pin hole and the second leg defines a key hole and a keyway. The pin hole and the key hole are coaxially aligned with one another and the keyway is in communication with the key hole. The pivot arm includes a pivot head sized and dimensioned to pass through the key hole and a neck sized and dimensioned to pass through the keyway as the pivot head passes through the key hole. The pivot arm is pivotal about the pivot pin within the gap between an unlocked position in which the neck is aligned with the keyway and a locked position in which the neck is misaligned with the keyway.

### BACKGROUND

### 1. Technical Field

The present disclosure relates to pivot joints and, more specifically, to pivot joints that allow for a quick connection to be assembled and disassembled while being confined to zero or single degrees-of-freedom of movement. A pivot joint is a joint that allows for rotation of one or more component(s) relative to one or more supporting component(s).

### SUMMARY

There is a continuing need for pivot joints that simplify assembly of the connection between components. In addition, there is a continuing need to reduce the number of components of a pivot joint.

This disclosure relates generally to a quick connect assembly that includes a pivot joint limited to a single degree of freedom. The quick connect assembly includes a connection block, a pivot pin, and a pivot arm. The pivot pin is fixed within the pivot arm such that the pivot pin and the pivot arm are insertable into the connection block when the pivot pin and the pivot arm are in an unlocked position relative to the connection block and are pivotal within the connecting block out of the unlocked position such that the pivot arm and pivot pin are locked within the connection block and confined to a single degree of freedom of movement within the connection block. The quick connect assembly may include a locking pin that is insertable through the connection block to fix the pivot arm and the pivot pin in a fixed position within the connection block.

In an aspect of the present disclosure, a quick connect assembly includes a first leg, a second leg, a pivot pin, and a pivot arm. The first and second legs define a gap therebetween. The first leg includes a pin hole that is defined therethrough. The second leg includes a key hole and a keyway that are defined therethrough. The pin hole and the key hole are coaxially aligned with one another and the keyway is in communication with the key hole. The pivot pin includes first, second and third parts. The pivot arm includes a neck and a pivot head. The pivot head is sized and dimensioned to pass through the key hole and the neck is sized and dimensioned to pass through the keyway as the pivot head passes through the key hole. The pivot arm is pivotal about a longitudinal axis of the pivot pin within the gap between an unlocked position in which the neck is aligned with the keyway and a locked position in which the neck is misaligned with the keyway.

In aspects, the first part of the pivot pin has a first diameter, the second part has a second diameter that is larger than the first diameter, and the third part has third diameter larger than the second diameter. The pivot head may include a fixation opening defined therethrough that is sized and dimensioned to fixedly receive the second part of the pivot pin. The second part may have a diameter that is sized and dimensioned to interfere with a wall defining the fixation opening such that the second part is fixed within the fixation opening by a press-fit connection. The pivot pin may be integrally formed with the pivot arm.

In some aspects, the first, second, and third parts of the pivot pin have diameters that are equal to one another. The pivot head may form a mounting flange and the second part of the pivot pin may include a planar surface that is parallel to the longitudinal axis. The planar surface may complement the mounting flat. The mounting flat may be secured to the planar surface to fix the pivot pin to the pivot arm. The second part of the pivot pin may define a fastener opening that is defined therethrough that is transverse to and intersects the longitudinal axis. The pivot arm may include a fastener passage that is defined therethrough that is aligned with the fastener opening of the pivot pin. The fastener passage and the fastener opening are configured to receive a fastener to fix the pivot arm to the pivot pin. The quick connect assembly may include a fastener that is disposed within the fastener opening and the fastener passage to fix the pivot arm to the pivot pin. The fastener may be threadably coupled to at least one of the pivot pin or the pivot arm.

In particular aspects, the pivot arm and the pivot pin are configured to releasably couple to the connection block in a fastenerless manner. The pivot arm may be configured to rotate about the longitudinal axis when the pivot arm is disposed within the gap in a range of 0 degrees to 360 degrees. In the locked position, the pivot arm may be confined in five degrees of freedom and is pivotal in one degree of freedom. Alternatively, in the locked position, the pivot arm may be fixed in six degrees of freedom. The quick connect assembly may include a locking pin that passes through a locking opening that is defined in each of the first and second legs to prevent the pivot arm from rotating about the longitudinal axis when the pivot arm is in the locked position.

In certain aspects, the pivot arm may include an actuation finger and an engagement finger on opposite sides of the pivot arm with the neck that extends from the pivot arm between the actuation finger and the engagement finger. The actuation finger may be configured to couple to an actuator and the engagement finger may be configured to engage a workpiece as the actuator rotates the pivot arm about the pivot pin.

In some aspects, the first and second legs may be integrally formed with one another to form a connection block. The connection block may include a stop surface and the pivot arm may include a stop. The stop of the pivot arm may engage the stop surface to limit rotation of the pivot arm about the pivot pin. The pivot pin may directly engage the first and second legs.

In another aspect of the present disclosure, a method of assembling a quick connect assembly includes passing a neck of a pivot arm and a pivot pin in a first position through a keyway and a key hole of a second leg such that the neck is positioned in a gap defined between a first leg and the second leg and pivoting the pivot arm about a longitudinal axis of the pivot pin from the first position to a second position in which the pivot arm is fixed in five degrees of freedom and pivotal in a sixth degree of freedom about the longitudinal axis of the pivot pin. The pivot pin may be fixed within the pivot arm.

In aspects, the method may include locking the pivot arm in the second position such that the pivot arm is prevented from the pivoting in the sixth degree of freedom after pivoting the pivot arm about the longitudinal axis.

In some aspects, pivoting the pivot arm about the longitudinal axis includes pivoting the pivot arm in a range of 1 degree to 5 degrees about the longitudinal axis.

In particular aspects, the method includes securing the pivot pin to the neck of the pivot arm before passing the neck and the pivot pin through the keyway and the key hole.

Further, to the extent consistent, any of the aspects described herein may be used in conjunction with any or all of the other aspects described herein.

### BRIEF DESCRIPTION OF THE DRAWINGS

Various aspects of the present disclosure are described hereinbelow with reference to the drawings, which are incorporated in and constitute a part of this specification, wherein:

FIG. 1 is a perspective view of a prior art pivot joint assembly;

FIG. 2 is a perspective view, with parts separated, of the prior art pivot joint assembly of FIG. 1;

FIG. 3 is a perspective view of a quick connect assembly provided in accordance with the present disclosure;

FIG. 4 is an enlarged perspective view, with parts separated, of a portion of the quick connect assembly of FIG. 3;

FIG. 5 is a perspective view of a connection block of the quick connect assembly of FIG. 3;

FIG. 6 is another perspective view of the connection block of FIG. 5;

FIG. 7 is another perspective view of the connection block of FIG. 5;

FIG. 8 is a side view of the pivot pin of the quick connect assembly of FIG. 3;

FIGS. 9-12 are a progression of perspective views showing a method of assembling the quick connect assembly of FIG. 3 in accordance with the present disclosure;

FIG. 13 is a perspective view of another pivot pin and pivot arm provided in accordance with the present disclosure;

FIG. 14 is a cross-sectional view of the pivot pin and the pivot arm of FIG. 13;

FIG. 15 is a perspective view, with part separated, of another quick connect assembly in the form of a trailer hitch provided in accordance with the present disclosure;

FIG. 16 is a perspective view of the quick connect assembly of FIG. 15 with a pivot pin fixed within a fixation opening of the pivot arm and positioned within the connection block;

FIG. 17 is a perspective view of the quick connect assembly of FIG. 16 with the pivot arm rotated to lock the pivot arm within the connection block;

FIG. 18 is a perspective view of the quick connect assembly of FIG. 17 with the pivot arm prevented from rotating by a locking pin inserted through the connection block;

FIG. 19 is a perspective view, with parts separated, of another quick connect assembly in the form of a piston and output shaft provided in accordance with the present disclosure;

FIG. 20 is a perspective view of the quick connect assembly of FIG. 19 with the output shaft received within a connection block of the piston; and

FIG. 21 is a perspective view of the quick connect assembly of FIG. 20 with a locking nut secured over a part of the output shaft to secure the output shaft within the connection block of the piston.

### DETAILED DESCRIPTION

Embodiments of the present disclosure are now described in detail with reference to the drawings in which like reference numerals designate identical or corresponding elements in each of the several views.

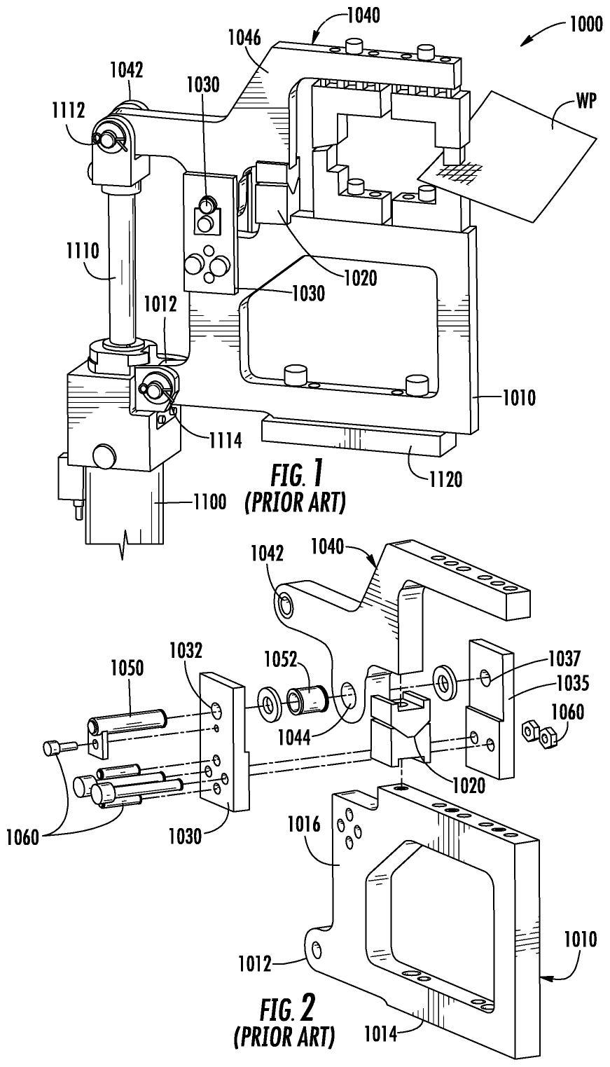

Referring to FIGS. 1 and 2, a prior art pivot joint assembly 1000 actuated by a linear actuator 1100 is illustrated and includes a support arm 1010, a stop 1020, locating brackets 1030, 1035, a pivot arm 1040, a pivot pin 1050, and fasteners 1060. The prior art pivot joint assembly 1000 is assembled by securing a mount 1012 of the support arm 1010 to a support mount 1114 of the linear actuator 1100 and fixing a lower member 1014 of the support arm 1010 to a fixed surface 1120. The locating brackets 1030, 1035 are fixed to locating holes 1016 of the support arm 1014 by some of the fasteners 1060 such that pin holes 1032 and 1037 of the locating brackets 1030, 1035 are aligned with one another. An actuation finger 1042 of the pivot arm 1040 is then secured to an end 1112 of a piston 1110 of the liner actuator 1100. With the pivot arm 1040 secured to the piston 1110, a pivot opening 1044 of the pivot arm 1040 is aligned with the pin holes 1032, 1037 of the locating brackets 1030, 1035 and the pivot pin 1050 is inserted through the pin holes 1032, 1037 and the pivot opening 1044 to pivotally couple the pivot arm 1040 to the support arm 1010. A bearing 1052 and additional fasteners 1060 may be used to provide additional rigidity to the pivot joint assembly 1000. When assembled, the pivot arm 1040 pivots about the pivot pin 1050 which is fixed the locating bracket 1030 by one of the fasteners 1060.

The prior art pivot joint assembly 1000 uses several components to position the pivot pin 1050 with each component increasing a variance in tolerances to the position of the pivot pin 1050. In addition, each component increases the possibility of movement with respect to the other components. Further, each component needs to be removed, inspected, and replaced each time the pivot joint assembly 1000. As such, as the number of components to position the pivot pin 1050 increase there may be an increase in the time required and the complexity of disassembling and reassemblying the assembly.

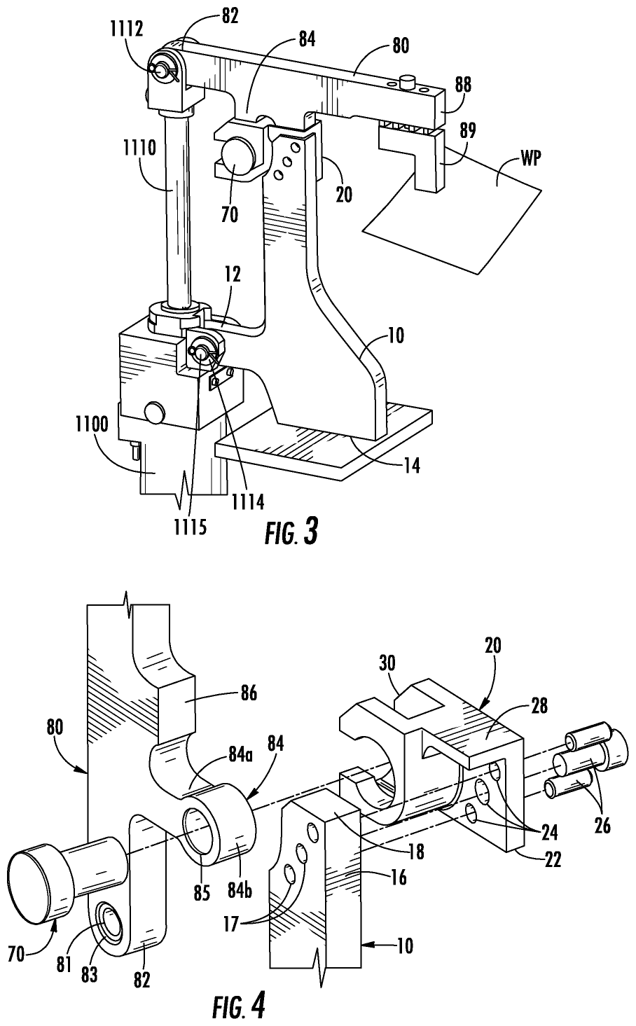

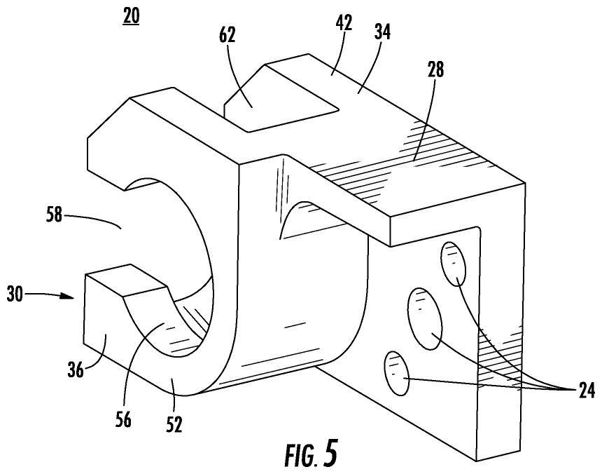

Referring now to FIGS. 3 and 4, an exemplary pivot joint assembly is provided in accordance with the present disclosure and includes a support arm 10, a connection block 20, a pivot pin 70, and a pivot arm 80. The support arm 10 includes an actuator mount 12 that is secured to a support mount 1114 of a linear actuator 1100 to position the support arm 10 relative to the linear actuator 1100. The support arm 10 also includes a base 14 that is secured or rests on a fixed surface. The support arm 10 may pivotally support the linear actuator 1100 about a support pin 1115 that passes through the actuator mount 12 and the support mount 1114. Alternatively, the linear actuator 1100 may be fixed to the actuator mount 12 of the support arm 10. The support arm 10 includes a locating mount 16 that extends from the base 14. As shown, the locating mount 16 extends from the base 14 in a direction perpendicular to the actuator mount 12; however, the locating mount 16 may extend in any direction relative to the actuator mount 12. The locating mount 16 may define locating openings 17 therethrough and may include an end surface 18 on an end of the locating mount 16 as detailed below.

The pivot arm 80 includes an actuator finger 82, a pivot finger 84, and an engagement finger 88. The actuator finger 82 is disposed in a first end portion of the pivot arm 80 and includes an actuation mount 83 defined through the actuation finger 82 that is configured to be secured to the end 1112 of a piston 1110 of the linear actuator 1100 that is secured to the support arm 10. The actuation mount 83 may receive a bearing 81 therein which may be press-fit into the actuation mount 83. The engagement finger 88 is disposed in a second end portion of the pivot arm 80 opposite the first end portion and is configured to engage a work piece. The engagement finger 88 may directly engage a work piece or may include an interface 89 that is releaseably coupled to the engagement finger 88 to engage a work piece.

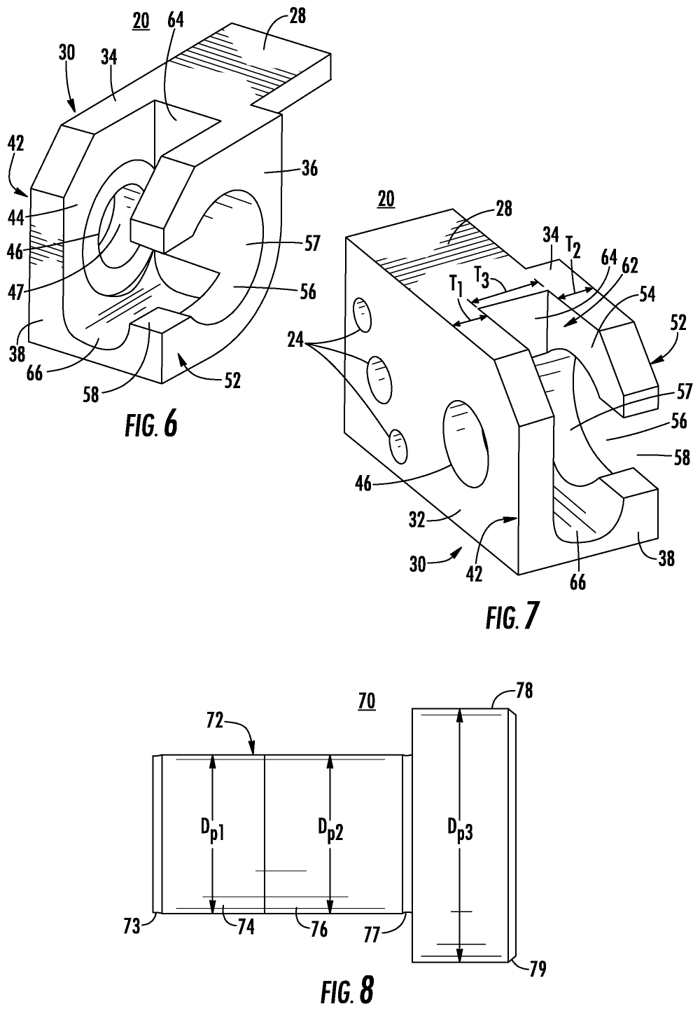

The pivot finger 84 includes a neck 84a extends from pivot arm 80 between the actuator finger 82 and the engagement finger 88 to a pivot head 84b. The pivot finger 84 has a thickness that is less than a gap 62 (FIG. 6) of the receiver 30. The pivot head 84b includes a fixation opening 85 defined therethrough. The pivot arm 80 may also include a stop 86 disposed adjacent the pivot finger 84 that is configured to limit rotation of the pivot arm 80 about the fixation opening 85. As shown, the stop 86 is disposed between the pivot finger 84 and the engagement finger 88 and extends from a body of the pivot arm 80 in the same direction as the pivot finger 84. In some embodiments, the stop 86 extends from the pivot finger 84 in a direction towards the engagement finger 88. Additionally or alternatively, the pivot arm 80 may include a stop 86 that is positioned between the pivot finger 84 and the actuator finger 82.

With additional reference to FIGS. 5-7, the connection block 20 includes a mounting portion 22 and a receiver 30 extending from the mounting portion 22. The mounting portion 22 may define one or more securement openings 24 that receive fasteners 26 therethrough to secure the mounting portion 22 to the locating mount 16 of the support arm 10. Specifically, the fasteners 26 may pass through the securement openings 24 of the connection block 20 and the locating openings 17 to secure the connection block 20 to the support arm 10. In some embodiments, the connection block 20 is secured to the support arm 10 in a fastenerless manner. For example, the connection block 20 may be welded, adhered, and/or monolithically formed with the support arm 10. The mounting portion 22 may include a stop surface 28. The stop surface 28 may extend orthogonally from a surface of the mounting portion 22 that engages the support arm 10 and/or that the fasteners 26 pass through.

The receiver 30 is configured to receive the pivot pin 80 such that the pivot pin 80 is rotatable within the receiver 30. The receiver 30 has a back surface 32, a top surface 34, a front surface 36, and a side surface 38. The terms back, top, front, and side as used herein are relative to the drawings as shown and should not be seen as limiting to an orientation of the receiver 30. The receiver 30 includes a first leg 42 that forms part of the back surface 32. The first leg 42 has a first inner surface 44 and defines a first thickness T₁ between the first inner surface 44 and the back surface 32. The first leg 42 includes a pin hole 46 that is a through circular hole defined between the first inner surface 44 and the back surface 32. The pin hole 46 is defined by a continuous or unbroken first race 47 and has a first hole diameter Dₕ₁.

The second leg 52 forms part of the front surface 36 and includes a second inner surface 54 that opposes the first inner surface 44 of the first leg 42 such that a gap 62 having a second thickness T₂ is defined between the first inner surface 44 and the second inner surface 54. The second leg 52 defines a third thickness T₃ between the second inner surface 54 and the front surface 36. The second leg 52 includes a key hole 56 that is defined through the front surface 36 and the second inner surface 54. The key hole 56 is substantially circular in shape and has a second hole diameter Dₕ₂. The second leg 52 also includes a keyway 58 that is defined between the front surface 36 and the second inner surface 54 which is in communication with the key hole 56 such that a second race 57 defining the key hole 56 is broken by the keyway 58. The key hole 56 and the keyway 58 are sized and dimensioned to allow the pivot finger 84 of the pivot arm 80 to pass through the second leg 52 in a predetermined alignment and to prevent the pivot finger 84 from passing through the second leg 52 when the pivot finger 84 is misaligned with the second leg 52. Specifically, the key hole 56 is sized and dimensioned to allow the pivot head 84b to pass through the second leg 52 and the keyway 58 is sized and dimensioned to allow the neck 84a to pass through the second leg 52 as detailed below.

The gap 62 is disposed between the first and second inner surfaces 44, 54 and is further defined by the first and second gap walls 64, 66. The gap 62 defines the second thickness T₂ between the first and second inner surfaces 44, 54 which is slightly larger than a thickness of the pivot finger 84 of the pivot arm 80 such that the pivot finger 84 is receivable within the gap 62. The first and second inner surfaces 44, 54 and/or the pivot finger 84 may be hardened and/or coated with friction reducing coating to reduce wear between the first and second inner surfaces 44, 54 and the pivot finger 84. The first and/or second gap wall 64, 66 may be planar or may be arcuate. As shown, the first gap wall 64 is substantially planar and extends between the top surface 34 and the second gap wall 66 and is parallel to the side surface 38 of the receiver. The second gap wall 66 is arcuate between the first and second inner walls 44, 54, extends from the first gap wall 64 to the side surface 38, and is substantially parallel to the top surface 34.

Referring to FIG. 8, the pivot pin 70 includes a shaft 72 and a pin head 78. The shaft has a first part 74 and a second part 76 which are each cylindrical in shape. The first part 74 may include a leading chamfer 73 that aids in insertion of the pivot pin 70 into the pin hole 46 as detailed below. The second part 76 may include a radius 77 between the second part 76 and the pin head 78 which provides a space between the second part 76 and the pin head 78. The pin head 78 may include a trailing chamfer 79 on an end of the pivot pin 70 opposite the leading chamfer 73. The pin head 78 may be referred to as a third part.

The first part 74 has a first pin diameter D_{P1} that is slightly less than the first hole diameter Dₕ₁ of the pin hole 46 (FIG. 6) such that the first part 74 is receivable within the pin hole 46 while allowing the first part 74 to rotate within the pin hole 46 without substantial slop. The first race 47 and/or the first part 74 may be hardened and/or coated with friction reducing coating to reduce wear between the first race 47 and the first part 74 as the pivot pin 70 rotates relative to the connection block 20 as detailed below.

The second part 76 is configured to be press-fit into the fixation opening 85 (FIG. 4) of the actuation finger 54 of the pivot arm 80 such that the second part 76, and thus the pivot pin 70, is fixed to the pivot arm 80. The second part 76 has a second pin diameter Dₚ₂ that is slightly larger than the diameter of the fixation opening 85 such that the interference between the second part 76 and the fixation opening 85 fixes the pivot pin 70 to the pivot arm 80. The second pin diameter Dₚ₂ is also larger than the first pin diameter Dₚ₁ such that the first part 74 freely passes through the fixation opening 85. The second pin diameter Dₚ₂ is less than the second pin hole diameter Dₕ₂ such that the second part 76, and thus the first part 74, freely pass through the key hole 56.

The pin head 78 has a third pin diameter Dₚ₃ that is greater than the second pin diameter Dₚ₂ and slightly less than the second hole diameter Dₚ₂ of the key hole 56 (FIG. 6) such that the pin head 78 is receivable within the key hole 56 while allowing the pin head 78 to rotate within the key hole 56 without substantially slop. The second race 57 and/or the pin head 78 may be hardened and/or coated with a friction reducing coating to reduce wear between the second race 57 and the pin head 78 as the pivot pin 70 rotates relative to the connection block 20 as detailed below.

In embodiments, the connection block 20 may be formed of steel, e.g., 1040 or 4140 steel, the pivot pin 70 may be formed of a bronze alloy, e.g., magnesium-bronze alloys, and the pivot arm 80 may be formed of steel, e.g., 1040 steel. It is contemplated that other material may be used that meet the structural and wear requirements of the components of the quick connect assembly 1 including, but not limited to, plastics, wood, composites, and other metals and metal alloys.

As detailed above, the connection block 20 and the pivot pin 70 interface directly with one another without a bearing disposed between one another. In addition, the quick connect assembly 1 due to the tolerances and the locking of the pivot arm 80 within the gap 62 of the connection block, the quick connect assembly 1 does not require alignment blocks or other features to maintain alignment between the pivot arm 80 and the support arm 10 such that the engagement finger 88 engages the workpiece where desired.

As detailed above, the connection block 20 has a monolithic or unitary construction such that the first and second legs 42, 52 are connected to one another. However, the first and second legs 42, 52 may be separately supported to define the gap 62 therebetween.

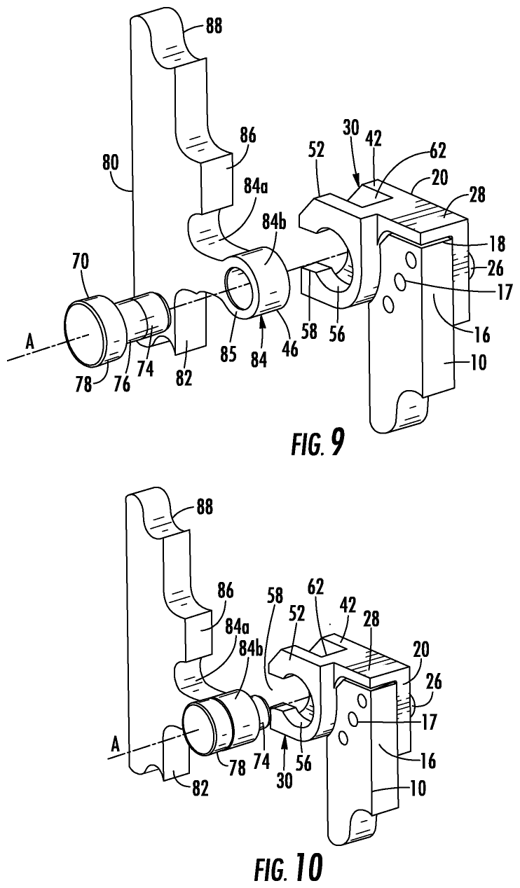

Referring now to FIGS. 9-12, the assembly of the quick connect assembly 1 is described in accordance with the present disclosure. Initially, the connection block 20 is secured to the support arm 10 to position the connection block 20 relative to an actuator, e.g., linear actuator 1100. To secure the connection block 20 to the support arm 10, the mounting portion 22 of the connection block 20 is aligned with the locating mount 16 of the support arm 10 such that the securement openings 24 are aligned with the locating holes 17. When the connection block 20 is aligned with the support arm 10, a stop surface 28 of the connection block 20 may be disposed over the end surface 18 of the support arm 10.

With the connection block 20 aligned with the support arm 10, the fasteners 26 are passed through the securement openings 24 and the locating holes 17 to secure the connection block 20 to the support arm 10. The fasteners 26 may be screws threadably engaged with the support arm 10 and/or the connection block 20. In some embodiments, the fasteners 26 may be bolts that include locking nuts to secure the support arm 10 to the connection block 20. Additionally or alternatively, the connection block 20 may be welded to or adhered to the support arm 10 to secure the connection block 20 to the support arm 10. In some embodiments, the locating holes 17 or securement openings 24 are replaced with locating pins that are received in the other of the locating holes 17 and securement openings 24 to align the connection block 20 to the support arm 10 while the connection block 20 is being secured, e.g., welded or adhered, to the support arm 10. In embodiments, the support arm 10 may be provided with the connection block 20 monolithically formed thereon such that the connection block 20 does not need to be independently secured to the support arm 10.

With the connection block 20 secured to the support arm 10, the pivot pin 70 is fixed to the pivot arm 80 as shown in FIG. 10. The pivot pin 70 is aligned with the fixation opening 85 of the pivot arm 80 such that the first part 74 of the pivot pin 70 is passed through the fixation opening 85. The pivot pin 70 is then pressed through the fixation opening 85 until the pin head 78 abuts the pivot head 84b of the pivot finger 84. As the pivot pin 70 is pressed through the fixation opening 85, the second part 76 interferes with the walls defining the fixation opening 85 such that the second part 76 is fixed within the fixation opening 85 via a press-fit. The second part 76 and/or the walls defining the fixation opening 85 may include features, e.g., ribs, to fix the second part 76 within the fixation opening 85.

With pivot pin 70 fixed within the fixation opening 84, the pivot arm 80 is aligned with the connection block 20 in a first position as shown in FIG. 10. Specifically, the pivot arm 80 is aligned such that a central longitudinal axis A-A of the pivot pin 70 passes through the center of the key hole 56 and the pin hole 46 (FIG. 6) and with the pivot arm 80 rotated about the axis A-A such that the neck 84a of the pivot finger 84 is aligned with the keyway 58.

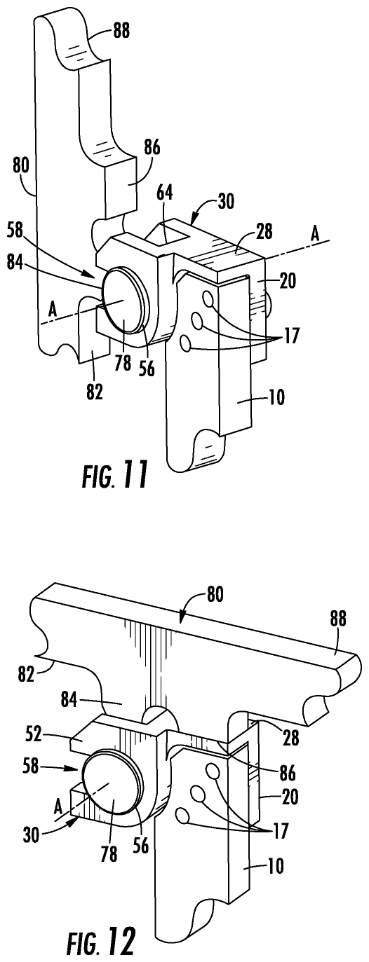

With the pivot arm 80 aligned with the connection block 20, the pivot arm 80 is positioned within the gap 62 of the connection block 20 by passing the pivot finger 84 and the pivot pin 70 through the second leg 52 until the first part 74 of the pivot pin 70 is received within the pin hole 46 and the pin head 78 of the pivot pin 70 is received within the key hole 56 as shown in FIG. 11. The pivot arm 80 is then rotated about the axis A-A from the first or unlocked position to a second or locked position about the axis A-A to lock the pivot arm 80 within the connection block 20 in which the neck 84a of the pivot arm 80 is misaligned with the keyway 58 of the connection block 20 as shown in FIG. 12. In embodiments, the tolerances of the keyway 58 and the neck 84a may be tight such that rotation of about 1 degree about the axis A-A locks the pivot arm 80 within the connection block 20. In some embodiments, tolerances of the keyway 58 and the neck 84a may require rotation of the pivot arm 80 in a range of about 3 degrees to about 10 degrees to lock the pivot arm 80 within the connection block 20.

With the pivot arm 80 locked within the connection block 20, the actuator finger 82 is secured to an actuator, e.g., end 1112 of the linear actuator 1100 (FIG. 3), such that the actuator pivots the pivot arm 80 about the axis A-A. As shown, as the pivot arm 80 is pivoted about the axis A-A, the engagement finger 88 is moved in an arc about the pivot pin 70. Locking the pivot arm 80 within the connection block 20, limits movement of the pivot arm 80 to one degree of freedom, e.g., rotation about the pivot pin 70, while preventing movement in other degrees of freedom, e.g., translation or rotation along or about other axes. As shown in FIGS. 11 and 12, rotation of the pivot arm 80 within the connection block 20 is limited to about 90 degrees by interaction of the pivot finger 84 with the first and second gap walls 64, 66 and/or the stop 86 with the stop surface 28. It is contemplated that rotation of the pivot arm 80 within the connection block 20 may be rotatable through a full 360 degrees of rotation or may be limited to less than 90 degrees of rotation depending on the desired application of the pivot joint assembly 1.

In some embodiments, the pivot pin 70 integrally formed with the pivot arm 80. In addition, the pivot pin 70 may be monolithically formed with the pivot arm 80. In such embodiments, it may not be necessary to press-fit the pivot pin 70 into the fixation opening 85 of the pivot finger 84.

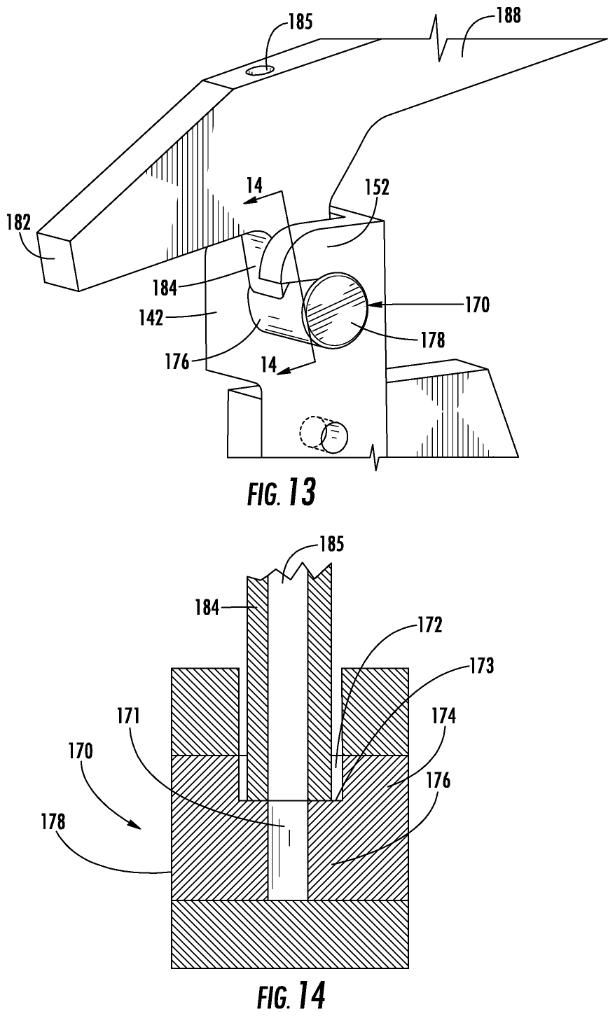

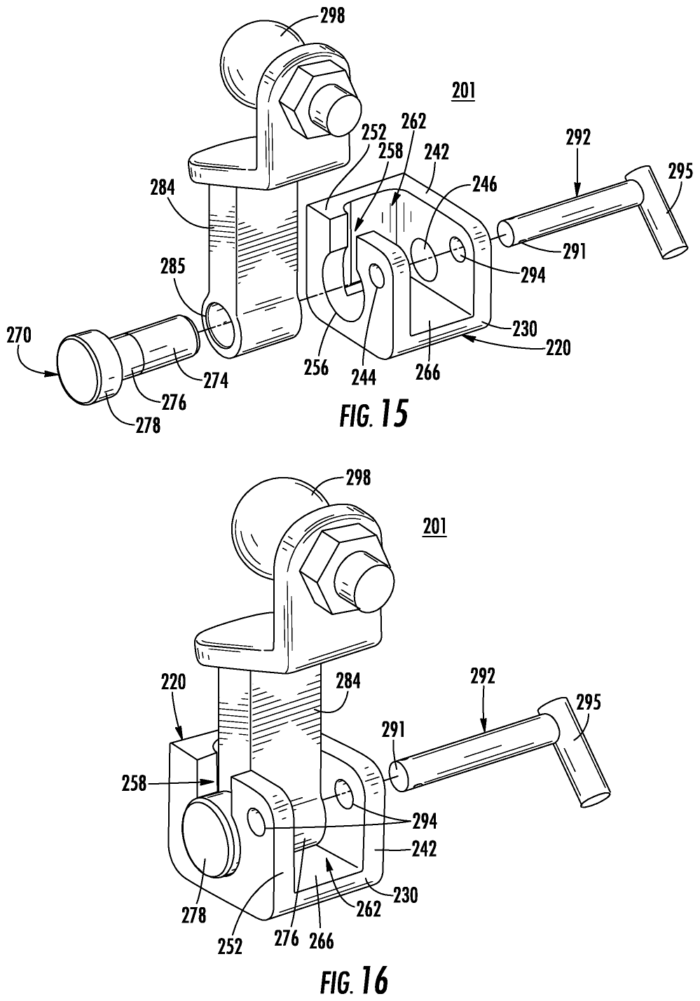

Referring now to FIGS. 13 and 14, another quick connect assembly 101 is disclosed in accordance with the present disclosure and includes a pivot pin 170 and a pivot arm 180. The quick connect assembly 101 is similar to the quick connect assembly 1 (FIG. 1) detailed above with like elements including a similar label with a “1” preceding the previous label. As such, like structures will not be detailed herein for brevity.

The pivot pin 170 is a single diameter pin having a first part 174, a second part 176, and a third part 178. The pivot pin 170 may be substantially cylindrical in shape with the first and third parts 174, 178 being substantially circular in cross section having the same diameter as one another. In some embodiments, the third part 178 has a diameter larger than the first part 178. The second part 176 includes a notch 172 that has a planar surface 173. The notch 172 may include a fastener opening 171 that passes into or through the second part 176 perpendicular to and intersecting the central longitudinal axis of the pivot pin 170. The fastener opening 171 may be threaded or may include smooth walls. The second part 176 may include a recess 175 defined in a surface opposite the planar surface 173 that is configured to receive an element of a fastener system, e.g., a nut 187a, and to prevent the element of the fastener system from rotating about a fastener axis F-F that is defined through the fastener opening 171. In some embodiments, the fastener opening 171 is a blind threaded hole that is configured to threadably receive a fastener.

The pivot arm 180 includes the pivot finger 184 that extends from the body of the pivot arm 180 in a similar manner to the pivot finger 84 detailed above. The pivot finger 184 includes a neck 184a and a pivot head or mounting flat 184b opposite the body of the pivot arm 180. The mounting flat 184b is sized and dimensioned to complement the planar surface 173 of the pivot pin 170. The neck 184a may form a tangent with an outer surface of the second part 176 of the pivot pin 170 such that the neck 184a smoothly transitions into the second part 176 when the mounting flat 184b is secured to the planar surface 173. The neck 184a includes a fastener passage 185 is defined longitudinally through the neck 184a. The pivot arm 180 includes a fastener 187 that passes through the fastener passage 185 and into the fastener opening 171 to releaseably couple the pivot arm 180 to the pivot pin 170. In some embodiments, the fastener passage 185 is a blind hole such that the fastener 187 passes through the second part 176 of the pivot pin 170 and into the neck 184a of the pivot arm 184 to fix the pivot pin 170 to the pivot arm 184.

To assemble the quick connect assembly 101, the pivot arm 180 is aligned with the pivot pin 170 such that the mounting flat 184b is mated with the planar surface 173 of the pivot pin 170 and the fastener passage 185 is aligned with the fastener opening 171. With the pivot arm 180 aligned with the pivot pin 170, the fastener 187 is passed through the fastener passage 185 and the fastener opening 171 to couple the pivot arm 180 to the pivot pin 170. Passing the fastener 187 through the fastener passage 185 and the faster opening 171 may include threadably coupling the fastener 187 to the fastener opening 171. Additionally or alternatively, passing the fastener 187 through the fastener passage 185 may include threadably coupling the fastener 187 to a nut 187a disposed within the recess 175 of the second part 176 of the pivot pin 170. In some embodiments, the neck 184a is welded or adhered to the planar surface 173 to secure the pivot arm 180 to the pivot pin 170. In such embodiments, the quick connect assembly 101 may include or may not include the fastener 187, the fastener passage 185, and the fastener opening 171.

With the pivot arm 180 coupled to the pivot pin 170, the neck 184a of the pivot arm 180 is passed through a keyway 158 of the connection block 120 and the pivot pin 170 is passed through the key hole 156 of the connection block 120 until the neck 184a is disposed within a gap 162 of the connection block 120 such that the first part 174 of the pivot pin 170 is disposed within a pin hole 142 of the connection block 120. The pivot arm 180 is then rotated about the pivot pin 170 to lock the pivot arm 180 within the connection block 120. As the pivot pin 170 has a single diameter, the key hole 156 may have the same diameter as the pin hole 142.

The quick connect assemblies detailed herein, e.g., quick connect assemblies 1, 101, may be used for a variety of applications that require preventing movement in five degrees of freedom while allowing movement in the single remaining degree of freedom, e.g., a pivot or hinge joint. For example, the quick connect assemblies may be used for industrial applications that allow for a high number of cycles while allowing for an easy and quick replacement when the part reaches an end of its service life. It is contemplated that the quick connect assemblies may be used for a variety of applications as a hinge or a pivot such as vehicular components like tailgates or doors, scissors, laptop hinges, household or industrial doors, kinematic applications like as four-link mechanisms such as front loaders on tractors, etc. In addition, the quick connect assemblies may be used for applications that can be disassembled and reassembled quickly. For example, the quick connect assemblies may be used to attach legs to a table or a trailer hitch to a vehicle as detailed below.

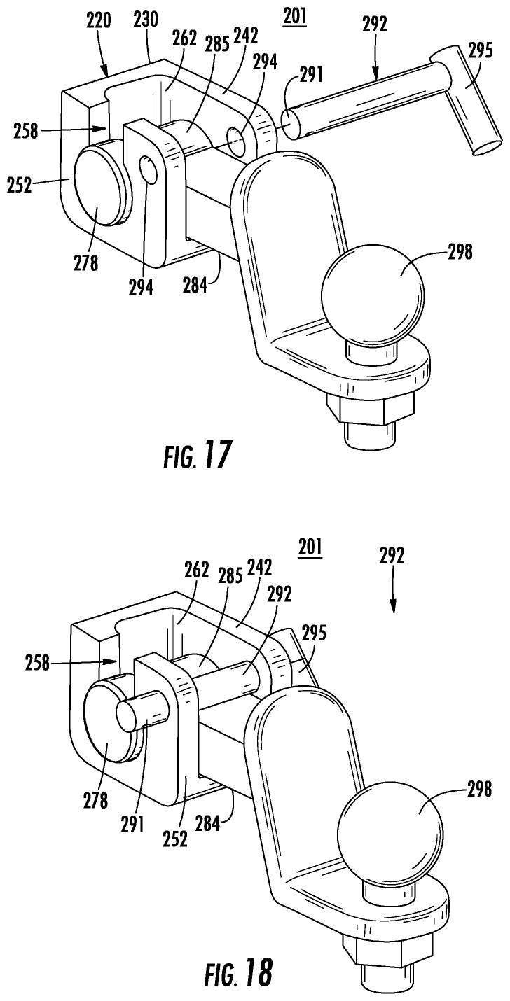

With reference to FIGS. 15-18, a quick connect assembly 201 is disclosed in accordance with the present disclosure. The quick connect assembly 201 is similar to the quick connect assembly 1 detailed above with like elements represented with similar labels preceded by a “2”. As such, similar elements of the quick connect assembly 201 will not be detailed for reasons of brevity.

The quick connect assembly 201 is configured to secure a removable trailer hitch 298 to a vehicle (not shown) with a connection block 220 secured to a frame (not shown) of the vehicle. The quick connect assembly 201 includes a pivot arm 280 which includes a pivot finger 284 that includes a fixation opening 285 defined therethrough and a pivot pin 270 configured to be fixed within the fixation opening 285. As shown, the pivot pin 270 includes a first part 274, a second part 276, and a third part or head 278 each having a diameter different from the other parts with the second part 276 configured to be fixed within the fixation opening 285 by a press-fit connection. However, the pivot pin 270 may have a single diameter and/or be fixed within the fixation opening 285 by a fastener or being welded within the fixation opening 285.

To assemble the quick connect assembly 201, i.e., install the removable trailer hitch 298, the pivot arm 280 is passed through a key hole 256 and a keyway 258 of the connection block 220 until the pivot arm 280 is positioned within a gap 262 of the connection block 220 such that the first part 274 of the pivot pin 270 is received within a pin hole 246 of the connection block 220 and the third part 278 is disposed within the key hole 256 of the connection block 220. As shown, to pass the pivot arm 280 through the keyway 258, the pivot arm 280 is in a vertical orientation. With the pivot arm 280 positioned within the gap 262, the pivot arm 280 is rotated to lock the pivot arm 280 within the connection block 220 as shown in FIG. 17, e.g., the pivot arm 280 is rotated to a horizontal position. The connection block 220 may include a gap wall 266 that defines the gap 262 which acts as a stop to maintain the pivot arm 280 in the horizontal position. With the pivot arm 280 locked within the connection block 220, a locking pin 292 is passed through locking openings 294 defined in first and second legs 242, 252 of the connection block 220 to prevent the pivot arm 280 from rotating out may be prevented from unintentionally being removed from the connection block 220 by detents 293 or a cotter pin (not shown) extending from or through an end portion 291 of the locking pin 292. The locking pin 292 may include a non-centered handle 295 on an end of the locking pin 292 opposite the end portion 291 to aid in insertion and/or removal of the locking pin 292.

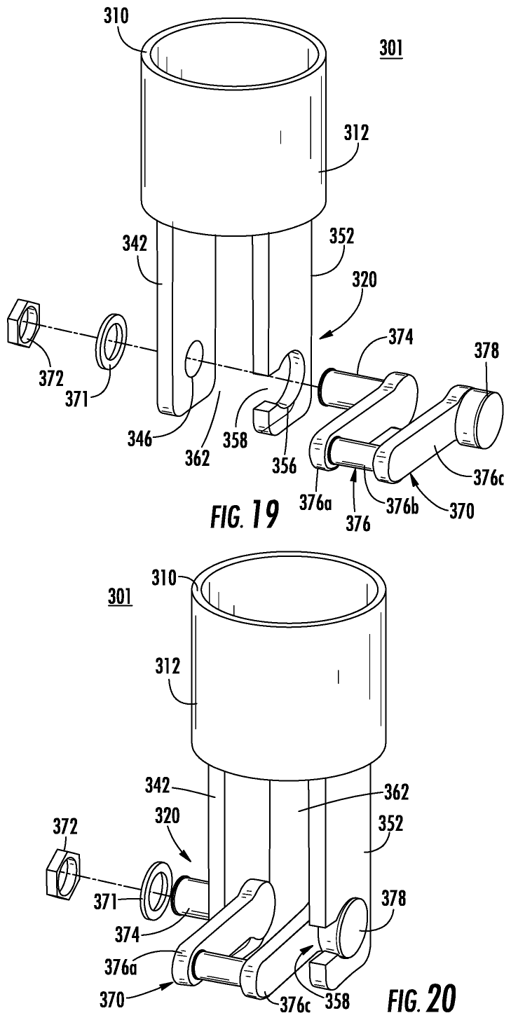

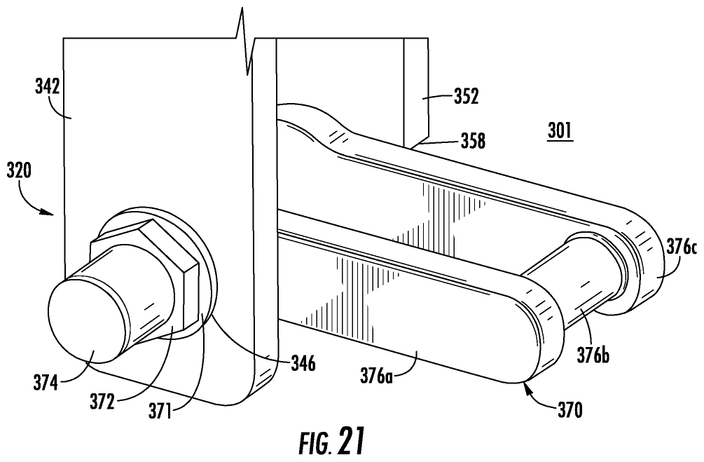

Referring to FIGS. 19-21, another quick connect assembly 301 is provided in accordance with the present disclosure. The quick connect assembly 301 is similar to the quick connect assembly 1 detailed above with like elements represented with similar labels preceded by a “3”. As such, similar elements of the quick connect assembly 301 will not be detailed for reasons of brevity.

The quick connect assembly 301 is a connection between a fixed element 310 and a crank or output shaft 370. The fixed element 310 includes a connection block 320 having a first leg 342 and a second leg 352 extending from a head 312 of the fixed element 310. The first leg 342 includes a pin hole 346 defined therethrough and the second leg 352 includes a key hole 356 and a keyway 358 defined therethrough.

The output shaft 370 is a combination of a pivot arm and a pivot pin as detailed above and includes a first part 374, a second part 376, and a third part 378. The first part 374 is substantially cylindrical in shape and is sized and dimensioned to pass through and rotate within the pin hole 346. The third part 378 is substantially cylindrical in shape and is sized and dimensioned to pass through and rotate within the key hole 356. The third part 378 is coaxially aligned with the first part 374. The second part 376 is similar to the pivot arms detailed above and interconnects the first and third parts 374, 378 which are similar to the pivot pins detailed above split into two separate elements. The second part 376 includes a first arm 376a and a second arm 376c that extend from a cylindrical bar 376b. The bar 376b is parallel to and axially offset from the first and third parts 374, 378. The first and second arms 376a, 376b are connected to opposite ends of the bar 376b and each connect the bar 376b to a respective one of the first or third parts 374, 378. The output shaft 370 also includes a washer 371 and a locking element 372. The washer 371 may be disposed over the first part 374 between the locking element 372 and the first leg 342. The locking element 372 may be threadably coupled over the first part 374 and may include a locking wire or pin (not shown) that passes through the locking element 372 to prevent the locking element 372 from backing off of the first part 374.

To assemble the fixed element 310 and the output shaft 370, the output shaft 370 is aligned with the fixed element 310 such that the first part 374 is aligned with the pin hole 346 and the third part 378 is aligned with the key hole 356 with the second arm 376b aligned with the keyway 358 as shown in FIG. 19. When the output shaft 370 is aligned with the fixed element 310, the first part 374 may be positioned within a gap 362 defined between the first and second legs 342, 352 of the fixed element 310. The first part 374 is then passed through the pin hole 346 until the first arm 376a abuts the first leg 342. When the first arm 376a abuts the first leg 342, the second arm 376b is disposed within the gap 362 and the third part 378 is positioned within the key hole 356 as shown in FIG. 20. The washer 371 is then passed over the first part 376 and the locking element 372 is passed over the first part 376 to position the washer 371 between the locking element 372 and the first leg 342. The locking element 372 is then secured to the first part 374 to prevent the locking element 372 from backing off of the first part 374. For example, a locking wire or pin may be passed through the locking element 372 and the first part 374 to prevent the locking element 372 from rotating relative to the first part 374.

While several embodiments of the disclosure have been shown in the drawings, it is not intended that the disclosure be limited thereto, as it is intended that the disclosure be as broad in scope as the art will allow and that the specification be read likewise. Any combination of the above embodiments is also envisioned and is within the scope of the appended claims. Therefore, the above description should not be construed as limiting, but merely as exemplifications of particular embodiments. Those skilled in the art will envision other modifications within the scope of the claims appended hereto.

What is claimed:

1. A quick connect assembly comprising:
a first leg including a pin hole defined therethrough;
a second leg including a key hole and a keyway defined therethrough, the keyway in communication with the key hole, the first and second legs defining a gap therebetween with the pin hole and the key hole being coaxially aligned with one another;
a pivot pin having a first part, a second part, and a third part; and
a pivot arm including a neck and a pivot head, the pivot head sized and dimensioned to pass through the key hole and the neck is sized and dimensioned to pass through the keyway as the pivot head passes through the key hole, the pivot arm pivotal about a longitudinal axis of the pivot pin within the gap between an unlocked position in which the neck is aligned with the keyway and a locked position in which the neck is misaligned with the keyway.

2. The quick connect assembly according to claim 1, wherein the pivot pin is integrally formed with the pivot arm.

3. The quick connect assembly according to claim 1, wherein, the first part has a first diameter, wherein the second part has a second diameter larger than the first diameter, and wherein the third part has a third diameter larger than the second diameter.

4. The quick connect assembly according to claim 1, wherein the pivot head includes a fixation opening defined therethrough that is sized and dimensioned to fixedly receive the second part of the pivot pin.

5. The quick connect assembly according to claim 4, wherein the second part has a diameter sized and dimensioned to interfere with a wall defining the fixation opening such that the second part is fixed within the fixation opening by a press-fit connection.

6. The quick connect assembly according to claim 1, wherein first, second, and third parts of the pivot pin have equal diameters to one another.

7. The quick connect assembly according to claim 6, wherein the pivot head forms a mounting flat and the second part of the pivot pin includes a planar surface parallel to the longitudinal axis that complements the mounting flat, the mounting flat secured to the planar surface to fix the pivot pin to the pivot arm.

8. The quick connect assembly according to claim 7, wherein second part of the pivot pin defines a fastener opening defined therethrough transverse to and intersecting the longitudinal axis, and wherein the pivot arm includes a fastener passage defined therethrough that is aligned with the fastener opening of the pivot pin, the fastener passage and the fastener opening configured to receive a fastener to fix the pivot arm to the pivot pin.

9. The quick connect assembly according to claim 8, further comprising a fastener disposed within the fastener opening and the fastener passage to fix the pivot arm to the pivot pin, the fastener threadably coupled to at least one of the pivot pin or the pivot arm.

10. The quick connect assembly according to claim 1, wherein the pivot arm and the pivot pin are configured to releaseably couple to the first and second legs in a fastenerless manner.

11. The quick connect assembly according to claim 1, wherein the pivot arm is configured to rotate about the longitudinal axis when the pivot arm is disposed within the gap in a range of 0° to 360°.

12. The quick connect assembly according to claim 1, wherein in the locked position, the pivot arm is confined in five degrees of freedom and is pivotal in one degree of freedom.

13. The quick connect assembly according to claim 1, wherein in the locked position, the pivot arm is fixed in six degrees of freedom.

14. The quick connect assembly according to claim 13, further comprising a locking pin that passes through a locking opening defined in each of the first and second legs to prevent the pivot arm from rotating about the longitudinal axis when the pivot arm is in the locked position.

15. The quick connect assembly according to claim 1, wherein the pivot arm includes an actuation finger and an engagement finger on opposite ends of the pivot arm with the neck extending from the pivot arm between the actuation finger and the engagement finger, the actuation finger configured couple to an actuator and the engagement finger configured to engage a workpiece as the actuator rotates the pivot arm about the pivot pin.

16. The quick connect assembly according to claim 1, wherein the first and second legs are integrally formed with one another to form a connection block.

17. The quick connect assembly according to claim 16, wherein the connection block includes a stop surface and the pivot arm includes a stop, the stop of the pivot arm engaging the stop surface to limit rotation of the pivot arm about the pivot pin.

18. The quick connect assembly according to claim 1, wherein the pivot pin directly engages the first and second legs.

19. A method of assembling a quick connect assembly, the method comprising:
passing a neck of a pivot arm and a pivot pin in a first position through a keyway and a key hole of a second leg such that the neck is positioned in a gap defined between a first leg and the second leg, the pivot pin fixed to the pivot arm;
pivoting the pivot arm about a longitudinal axis of the pivot pin from the first position to a second position in which the pivot arm is fixed in five degrees of freedom and pivotable in a sixth degree of freedom about the longitudinal axis of the pivot pin.

20. The method according to claim 19, further comprising locking the pivot arm in the second position such that the pivot arm is prevented from pivoting in the sixth degree of freedom after pivoting the pivot arm about the longitudinal axis.
